(19) United States
(12) Patent Application Publication
(10) Pub. No.: US 2014/0198963 A1
(43) Pub. Date: Jul. 17, 2014

(54) SEGMENTATION METHOD OF MEDICAL IMAGE AND APPARATUS THEREOF

(71) Applicant: Infinitt Healthcare Co. Ltd., Seoul (KR)

(72) Inventors: Soo Kyung Kim, Seoul (KR); Han Young Kim, Seoul (KR)

(73) Assignee: IInfinitt Healthcare Co. Ltd., Seoul (KR)

(21) Appl. No.: 14/211,324

(22) Filed: Mar. 14, 2014

Related U.S. Application Data
(63) Continuation of application No. PCT/KR2012/007332, filed on Sep. 13, 2012.

(30) Foreign Application Priority Data
Sep. 14, 2011 (KR) 10-2011-0092365

(51) Int. Cl. G06T 7/00

(52) U.S. Cl. CPC G06T 7/0012
USPC 382/128

(57) ABSTRACT

The present invention relates to a segmentation method and apparatus of a medical image. The segmentation method of a medical image according to an example of the present invention includes the steps of: extracting information about a position of a pointer according to a user input from a slice medical image displayed on a screen; determining a segmentation region including the position of the pointer, based on information about the slice medical image related to the extracted information about the position of the pointer; preliminarily displaying the determined segmentation region in the slice medical image; and when the preliminarily displayed segmentation region is affirmed by a user, determining the affirmed segmentation region as a lesion diagnosis region for the slice medical image.

### CROSS-REFERENCE TO RELATED APPLICATIONS

This application is a continuation of PCT/KR2012/007332 filed on Sep. 13, 2012, which claims priority to Korean Patent Application No. 10-2011-0092365 filed on Sep. 14, 2011, the entire contents of which applications are incorporated herein by reference

### TECHNICAL FIELD

The present invention relates to segmentation in a medical image and, more particularly, to a segmentation method and apparatus in a medical image, wherein a user may affirm a seed for generating a three-dimensional (3D) segmentation volume through interactive segmentation with a user in a slice medical image and thus an optimized 3D segmentation volume may be obtained.

### BACKGROUND ART

It is important to diagnose cancer in the early stages as far as possible and to carefully monitor cancer. A doctor is interested in not only a primary tumor, but also a secondary tumor that may have possibly metastasized through the remainder of the main body.

A lesion, such as a tumor, can be diagnosed and monitored through a 3D segmentation volume. The 3D segmentation volume can be formed by the segmentation of each of a plurality of two-dimensional (2D) medical images.

In a conventional 3D segmentation volume, when a doctor, that is, a user, selects a specific position to be monitored in a 2D medical image, 2D segmentation is performed using information about the selected position, and a 3D segmentation volume is generated based on a result of the performed 2D segmentation.

In such a conventional segmentation method, a user can be aware of output generated through a 3D segmentation volume generated after a 3D segmentation process is fully finished because the user cannot be aware of the results of segmentation performed on a specific position selected by the user in a 2D medical image. That is, if a generated 3D segmentation volume is not satisfactory, the user has to reselect the position of a lesion to be checked in the 2D medical image and checks results for the reselected position through a 3D segmentation volume. Accordingly, such as process may be repeated, which may give a load to a system or apparatus for generating a segmentation volume and make the user inconvenient.

Accordingly, there is a need for a method of obtaining an optimized 2D segmentation seed in order to obtain a satisfactory 3D segmentation volume.

### SUMMARY OF THE DISCLOSURE

The present invention has been made keeping in mind the above problems occurring in the prior art, and an object of the present invention is to provide a segmentation method and apparatus of a medical image, which are capable of obtaining an optimum segmentation seed through an interaction with a user in a slice medical image.

Furthermore, an object of the present invention is to provide a segmentation method and apparatus of a medical image, which are capable of obtaining an optimum 3D segmentation volume by obtaining an optimum segmentation seed in a slice medical image and thus reducing a load for obtaining the 3D segmentation volume.

Furthermore, an object of the present invention is to provide a segmentation method and apparatus of a medical image, which enable a user to confirm an optimum segmentation seed by preliminarily displaying a segmentation region to be determined by a user's confirmation in a slice medical image.

In order to achieve the above objects, a segmentation method of a medical image in accordance with an embodiment of the present invention includes steps of extracting information about the position of a pointer according to a user input from a slice medical image displayed on a screen; determining a segmentation region including the position of the pointer, based on information about the slice medical image related to the extracted information about the position of the pointer; preliminarily displaying the determined segmentation region in the slice medical image; and when the preliminarily displayed segmentation region is selected by a user, determining the affirmed segmentation region as a lesion diagnosis region for the slice medical image.

Here, the determining the affirmed segmentation region step may include determining the lesion diagnosis region as a seed for the segmentation of a 3D volume image.

The determining the segmentation region step may include steps of removing granular noise from the slice medical image; distinguishing a lesion diagnosis portion using a profile of the slice medical image from which the granular noise has been removed; and determining the segmentation region including the position of the pointer, based on the distinguished lesion diagnosis portion and the information about the slice medical image that is related to the extracted information about the position of the pointer.

The extracting step may include detecting optimum position information in a predetermined neighboring region including the position of the pointer and other positions having a brightness value same as the brightness value of the position of the pointer, and the determining the segmentation region step may include determining the segmentation region including the position of the pointer, based on the information about the slice medical image that is related to the detected optimum position information.

The extracting step may include comparing a mean value of brightness values of the predetermined neighboring region with the brightness value of the position of the pointer and detecting position information corresponding to the mean value as the optimum position information if the brightness value of the position of the pointer lies out of a predetermined tolerance range of the mean value.

The determining the segmentation region step may include steps of estimating a range of a brightness value based on the information about the slice medical image that is related to the extracted information about the position of the pointer; determining a first segmentation region including the position of the pointer using the estimated range of the brightness value; applying a predetermined fitting model to the determined first segmentation region; and determining an optimum segmentation region from the first segmentation region using the fitting model.

The determining the segmentation region step may include detecting one or more segmentation regions corresponding to a brightness value of the position of the pointer using density distribution information of the slice medical image and determining a segmentation region, including the position of the pointer, from the detected one or more segmentation regions.

A segmentation method of a medical image in accordance with another embodiment of the present invention includes steps of determining a segmentation region including the position of a pointer, based on information about a first slice medical image that is related to information about the position of the pointer in the first slice medical image; preliminarily displaying the determined segmentation region in the first slice medical image; when the preliminarily displayed segmentation region is affirmed by a user, determining the affirmed segmentation region as a seed for the segmentation of a 3D volume image; and determining the segmentation region of each of a plurality of slice medical images related to the first slice medical image based on the determined seed.

Moreover, a step of generating a 3D segmentation volume using the determined seed and the segmentation region of each of the plurality of the slice medical images may be further included.

A segmentation apparatus of a medical image in accordance with an embodiment of the present invention includes a processor. The processor may include an extraction unit for extracting information about the position of a pointer according to a user input from a slice medical image displayed on a screen; a determination unit for determining a segmentation region including the position of the pointer, based on information about the slice medical image related to the extracted information about the position of the pointer; a display unit for preliminarily displaying the determined segmentation region in the slice medical image; and a decision unit for determining, when the preliminarily displayed segmentation region is affirmed by a user, the affirmed segmentation region as a lesion diagnosis region for the slice medical image.

A segmentation apparatus of a medical image in accordance with another embodiment of the present invention includes another processor. The other processor may include a first region determination unit for determining a segmentation region including the position of a pointer, based on information about a first slice medical image that is related to information about the position of the pointer in the first slice medical image; a display unit for preliminarily displaying the determined segmentation region in the first slice medical image; a seed determination unit for determining, when the preliminarily displayed segmentation region is affirmed by a user, the affirmed segmentation region as a seed for the segmentation of a 3D volume image; and a second region determination unit for determining a segmentation region of each of a plurality of slice medical images related to the first slice medical image based on the determined seed.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows a flowchart illustrating a segmentation method of a medical image in accordance with an embodiment of the present invention;

FIG. 2 shows a flowchart of an embodiment of step S140 shown in FIG. 1;

FIG. 3 shows a flowchart of an embodiment of step S150 shown in FIG. 1;

FIG. 4 shows a flowchart of a segmentation method of a medical image in accordance with another embodiment of the present invention;

FIG. 5 shows an exemplary diagram of a medical image for illustrating the flowchart shown in FIG. 4;

FIG. 6 shows the configuration of a segmentation apparatus of a medical image in accordance with an embodiment of the present invention;

FIG. 7 shows the configuration of an embodiment of a determination unit shown in FIG. 6; and

FIG. 8 shows the configuration of a segmentation apparatus of a medical image in accordance with another embodiment of the present invention.

### DETAILED DESCRIPTION OF THE DISCLOSURE

In addition to the above objects, other objects and characteristics of the present invention will become evident from the following description in conjunction with the accompanying drawings.

Preferred embodiments of the present invention are described in detail with reference to the accompanying drawings. A detailed description of known functions and constitutions is omitted if it is deemed to make the gist of the present invention unnecessarily vague.

However, the present invention is not restricted or limited by the embodiments. The same reference numerals suggested in each drawing denote the same elements.

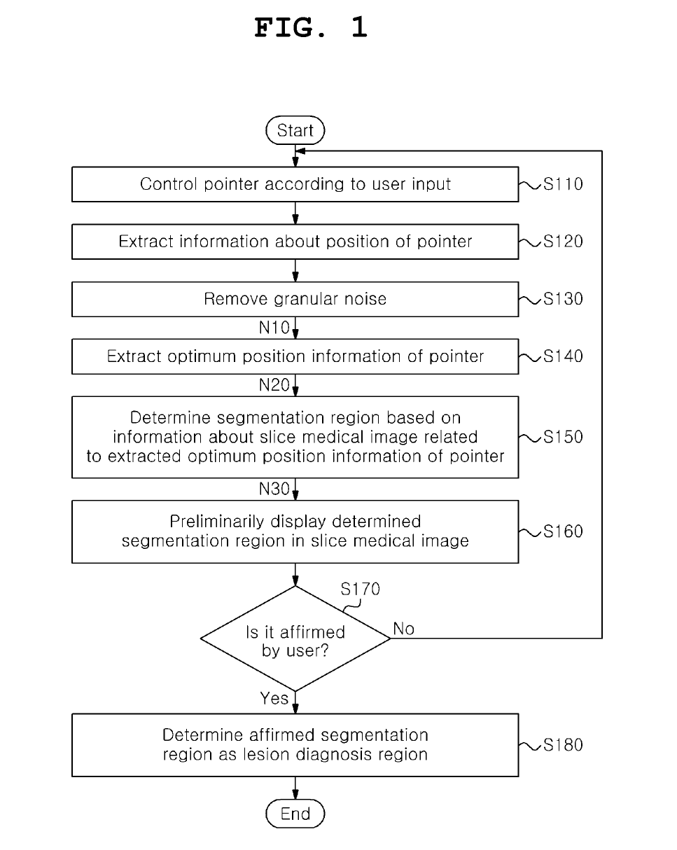

Hereinafter, a segmentation method and apparatus of a medical image in accordance with an embodiment of the present invention is described in detail with reference to FIGS. 1 to 8.

FIG. 1 shows a flowchart illustrating a segmentation method of a medical image in accordance with an embodiment of the present invention and shows a process of determining a segmentation seed for generating a 3D segmentation volume in a slice medical image.

Referring to FIG. 1, in the segmentation method, a pointer that is displayed in a slice medical image selected by a user is controlled in response to a user input, for example, a mouse movement at step S110.

When the position of the pointer is changed or the pointer is stopped by control of the pointer according to the user input, information about the position (or position information) of the corresponding pointer is extracted at step S120.

Here, the information about the position of the pointer may be information about coordinates in the slice medical image.

When the information about the position of the pointer is extracted, granular noise is removed from the slice medical image, information about the optimum position (or optimum position information) of the pointer is extracted based on information about the slice medical image that is related to the extracted information about the position of the pointer at steps S130 and S140.

Step S130 of removing granular noise may be performed before a corresponding slice medical image is displayed on a screen when the slice medical image is selected by the user.

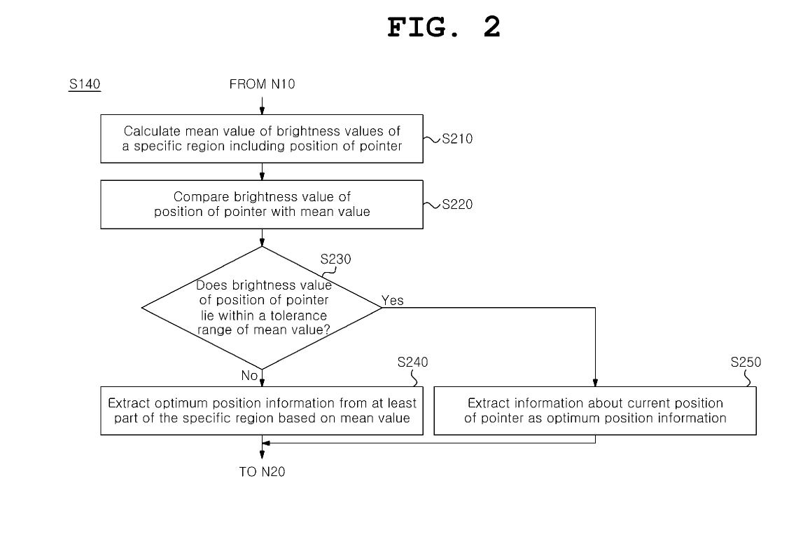

The information about the optimum position of the pointer at step S140 may become a seed point for determining a segmentation region, and step S140 of extracting the optimum position information is described in detail below with reference to FIG. 2.

FIG. 2 shows a flowchart of an embodiment of step S140 shown in FIG. 1.

Referring to FIG. 2, step S140 of extracting the optimum position information includes calculating a mean value of brightness values of a specific region including the position of the pointer, for example, a circular region having a specific size around the position of the pointer in response to a user's behavior or a user input at step S210.

Here, the brightness value of the circular region may be information about the slice medical image corresponding to the circular region in the slice medical image.

When the mean value of brightness values of the specific region including the position of the pointer is calculated at step S210, the calculated mean value is compared with a brightness value of position of the corresponding pointer. Whether the brightness value of the position of the pointer falls (or lies) within a tolerance range of the mean value is determined based on a result of the comparison at steps S220 and S230.

For example, whether the brightness value of the position of the pointer is placed between two values: “the mean value−a” and “the mean value+a”. Here, the value ‘a’ may be dynamically determined according to circumstances or may be pre-determined.

If, as a result of the determination at step S230, the brightness value of the position of the pointer lies out of the tolerance range of the mean value, optimum position information is extracted using the brightness values included in the specific region based on the mean value at step S240.

Here, the optimum position information in the specific region may be information about a position having a brightness value corresponding to the mean value, from the brightness values of positions included in the specific region. If the number of brightness values corresponding to the mean value is plural, a position nearest to the position of the pointer, which is among the positions having the brightness value corresponding to the mean value, may be extracted as the optimum position information. The position nearest to the position of the pointer may be extracted as the optimum position information, but the present invention is not limited thereto. A specific position having the mean value may be randomly extracted as the optimum position information.

On the contrary if, as a result of the determination at step S230, the brightness value of the position of the pointer is present (or falls) within the tolerance range of the mean value, the current position of the pointer is extracted as the optimum position information at step S250.

Referring back to FIG. 1, when the optimum position information of the pointer is extracted at step S140, a segmentation region is determined based on information about the slice medical image that is related to the extracted optimum position information of the pointer at step S150.

Here, the segmentation region determined at step S150 may be determined in various ways.

For example, the segmentation region determined at step S150 may be determined based on a distinguished lesion diagnosis portion and information about the position of the pointer or the optimum position information of the pointer after distinguishing the lesion diagnosis portion using the profile of the slice medical image.

For another example, in relation to the segmentation region determined at step S150, a segmentation region including the position of the pointer in one or more segmentation regions or the optimum position information may be determined from the one or more segmentation regions detected using density distribution information of the slice medical image. The one or more segmentation regions correspond to a brightness value for the optimum position information of the pointer.

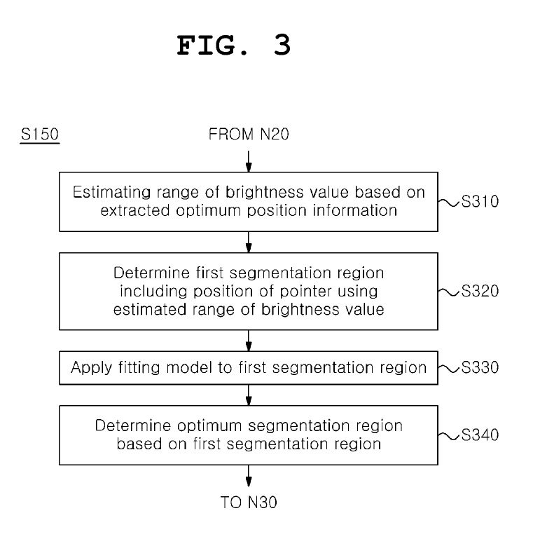

For yet another example, in relation to the segmentation region determined at step S150, an optimum segmentation region may be determined through a specific processing process, which is described with reference to FIG. 3.

FIG. 3 shows a flowchart of an embodiment of step S150 shown in FIG. 1.

Referring to FIG. 3, step S150 of determining the segmentation region includes estimating a range of a brightness value for determining a segmentation region based on medical image information, for example, a brightness value for the optimum position information extracted at step S140, at step S310.

Here, the range of the brightness value may be estimated by applying a specific standard deviation on the basis of the brightness value of the optimum position information or may be estimated by designating a range of a predetermined value.

When the range of the brightness value is estimated, a first segmentation region corresponding to the range of the brightness value is determined using the estimated range of the brightness value at step S320.

Here, the first segmentation region preferably includes the position of the pointer according to the user input or the extracted optimum position information.

When the first segmentation region is determined, an optimum segmentation region is determined based on the first segmentation region by applying a predetermined fitting model to the determined first segmentation region at steps S330 and S340.

Here, the fitting model may include a deformable model, a snake model, etc. The fitting model, such as the deformable model or the snake model, can be modified within a range that is evident to those skilled in the art to which the present invention pertains in order for the fitting model to be applied to steps S330 and S340.

Referring back to FIG. 1, when the optimum segmentation region including the position of the pointer or the optimum position information is determined according to the flowchart of FIG. 3, the determined segmentation region, that is, the optimum segmentation region is preliminarily displayed in the slice medical image at step S160.

When the optimum segmentation region preliminarily displayed on the screen is affirmed by the user, the affirmed segmentation region is determined as a lesion diagnosis region in the slice medical image at steps S170 and S180.

Here, the lesion diagnosis region, that is, the segmentation region affirmed by the user, may become a segmentation seed for generating a 3D segmentation volume.

Various methods, such as a click or double clock on the pointer or entering a shortcut key, may be applied to a method of determining, by the user, the segmentation region displayed on the screen at step S170.

On the contrary, when the segmentation region preliminarily displayed on the screen is not affirmed by the user at step S170, that is, the user does not satisfy the corresponding segmentation region, step S110 of moving and extracting the position of the pointer is performed again.

As described above, in accordance with the present invention, pre-segmentation for preliminarily determining a segmentation region using information about the position of a pointer is performed, an optimum segmentation region determined by the pre-segmentation is preliminarily displayed in a slice medical image. Accordingly, a lesion diagnosis region, that is, a segmentation seed, can be determined in response to a user' affirmation (or selection), and thus an optimum segmentation seed for generating an optimum 3D segmentation volume can be determined.

Furthermore, the present invention is advantageous in that a user input becomes simple and a user interface also become simple because a pre-segmentation process is performed based on information about the position of a pointer.

Furthermore, the present invention can improve 3D segmentation performance and increase satisfaction of a user because the user can check a segmentation region preliminarily displayed in a slice medical image and determine a segmentation seed.

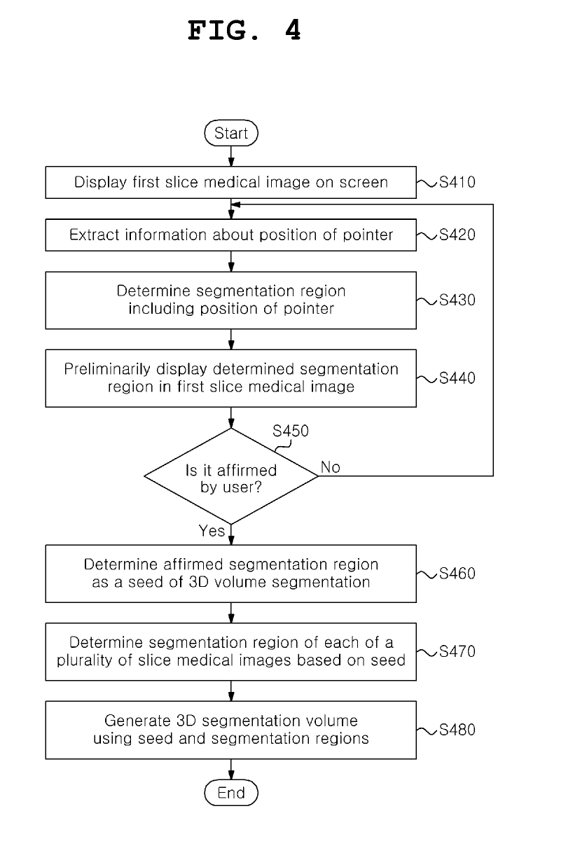

FIG. 4 shows a flowchart of a segmentation method of a medical image in accordance with another embodiment of the present invention and shows a process of generating a 3D segmentation volume using a determined seed after a pre-segmentation process.

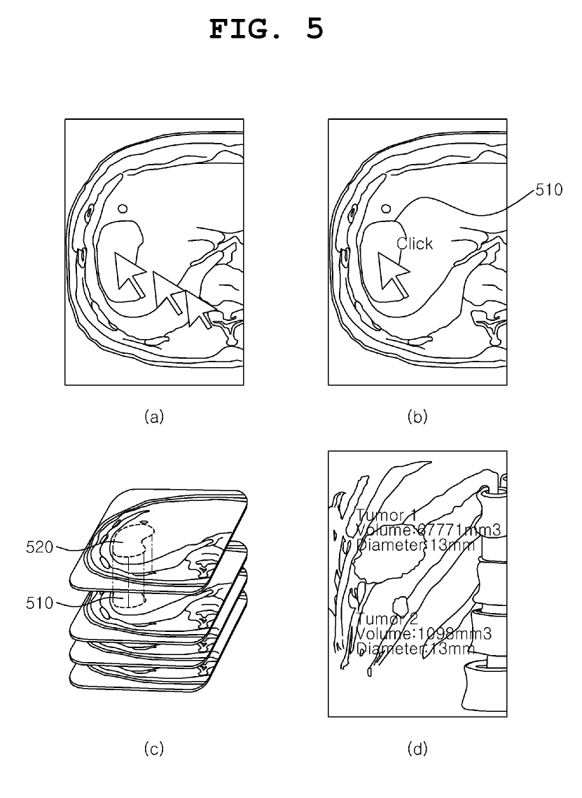

FIG. 5 shows an exemplary diagram of a medical image for illustrating the flowchart shown in FIG. 4. The operation of FIG. 4 is described below with reference to FIG. 5.

In the segmentation method of the present invention, as shown in FIG. 5A, a first slice medical image for determining a segmentation seed is displayed on a screen, and information about the position of, for example, a pointer or mouse that has been moved in response to a user input is extracted in the first slice medical image at steps S410 and S420.

Here, in a process of extracting the information about the position of the pointer, the information about the position of the pointer may be extracted when the pointer moves, or the information about the position of the pointer may be extracted when a movement of the pointer is stopped.

In the process of extracting the information about the position of the pointer at step S420, the optimum position information of the pointer may be extracted by the process shown in FIG. 2. That is, a brightness value for the information about the position of the pointer is compared with the mean value of brightness values of predetermined neighboring regions including the position of the pointer. If the brightness of the position of the pointer lies out of a predetermined tolerance range of the mean value, optimum position information is extracted from the neighboring regions. If the brightness value for the information about the position of the pointer lies within the tolerance range of the mean value, information about the position of the corresponding pointer is extracted as optimum position information.

When the information about the position of the pointer or the optimum position information is extracted, a segmentation region including the position of the pointer is determined based on information about a first slice medical image related to the extracted information about the position of the pointer or the extracted optimum position information, that is, a brightness value at step S430.

Likewise, the segmentation region determined at step S430 may be an optimum segmentation region determined by the process shown in FIG. 3, and the segmentation region may be determined in various ways described with reference to FIG. 1.

That is, at step S430, a range of a brightness value may be estimated based on the brightness value for the extracted optimum position information, a first segmentation region including the position of the pointer may be determined using the range of the brightness value, and an optimum segmentation region may be determined by applying a predetermined fitting model to the determined first segmentation region.

When the segmentation region is determined at step S430, the determined segmentation region is preliminarily displayed in the first slice medical image as shown in FIG. 5A, at step S440.

After the segmentation region is preliminarily displayed in the first slice medical image, if the user satisfies the preliminarily displayed segmentation region, the user affirms and determines the preliminarily displayed segmentation region using a method, such as clicking on the pointer as shown in FIG. 5B, at step S450.

When the user affirms and determines the segmentation region preliminarily displayed in the first slice medical image, the selected segmentation region is determined to be a seed for performing 3D volume segmentation at step S460.

On the contrary, if the segmentation region preliminarily displayed on the screen is not affirmed by the user at step S450, that is, the user does not satisfy the corresponding segmentation region, step S420 of moving and extracting the position of the pointer is performed again.

When the seed is affirmed by the user at step S460, the segmentation region 520 of each of a plurality of slice medical images related to the first slice medical image is determined based on the determined seed 510 as shown in FIG. 5C, at step S470.

When the segmentation region of each of the plurality of the slice medical images is determined, a 3D segmentation volume is generated using the determined segmentation regions of the first slice medical image, that is, the seed and the segmentation region of each of the slice medical images as shown in FIG. 5D, at step S480.

As described above, the present invention can generate an optimum 3D segmentation volume because the segmentation regions of other slice medical images are determined using an optimum segmentation seed and a 3D segmentation volume is generated using the determined segmentation regions.

Furthermore, the present invention can reduce the number of times that a satisfactory 3D segmentation volume is generated because an optimum seed is affirmed by a user.

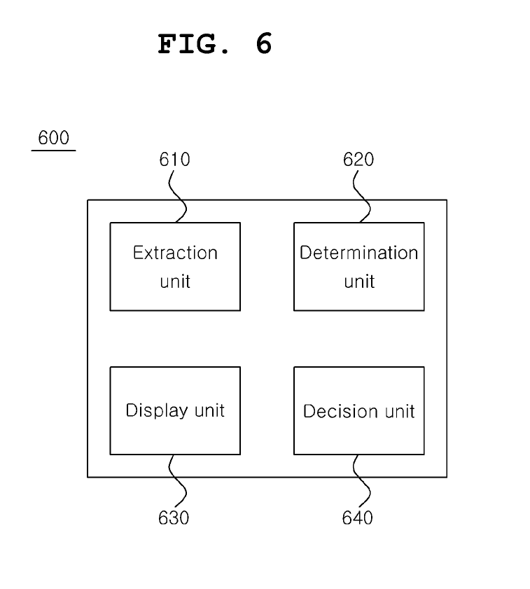

FIG. 6 shows the configuration of a segmentation apparatus of a medical image in accordance with an embodiment of the present invention and shows the configuration of the apparatus for the flowchart of FIG. 1.

Referring to FIG. 6, the segmentation apparatus 600 includes an extraction unit 610, a determination unit 620, a display unit 630, and a decision unit 640.

The extraction unit 610 extracts information about the position of a pointer according to a user input from a slice medical image displayed on a screen.

Here, the extraction unit 610 may continue to extract information about the position of the pointer in real time and may not extract information about the position of the pointer while the pointer moves in response to a user input, but may extract information about the position of the pointer only when the pointer is fixed.

The determination unit 620 determines a segmentation region including the position of the pointer, based on information about the slice medical image that is related to the information about the position of the pointer that has been extracted by the extraction unit 610.

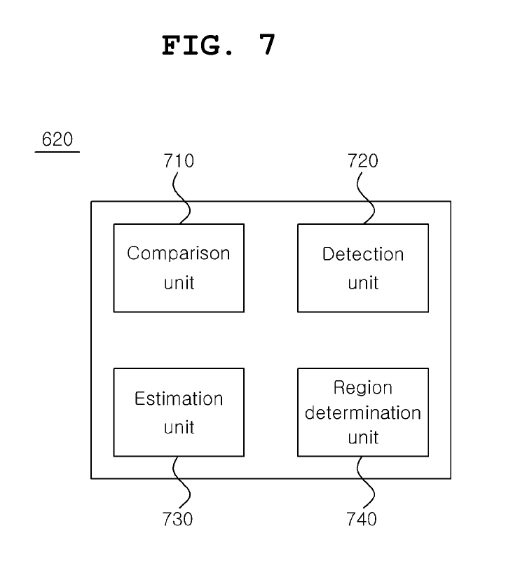

Here, as in an example shown in FIG. 7, the determination unit 620 may include a comparison unit 710, a detection unit 720, an estimation unit 730, and a region determination unit 740.

The comparison unit 710 compares a brightness value of the position of the pointer, extracted by the extraction unit 610, with the mean value of brightness values of predetermined neighboring regions including the position of the pointer.

The detection unit 720 detects optimum position information in the predetermined neighboring regions if the brightness value of the position of the pointer lies out of a predetermined tolerance range of the mean value as a result of the comparison between the brightness of the position of the pointer and the tolerance range of the mean value and detects corresponding information about the position of the pointer as optimum position information if the brightness value of the position of the pointer lies within the tolerance range of the mean value.

The estimation unit 730 estimates a range of a brightness value for segmentation based on the brightness value of the optimum position information that has been detected by the detection unit 720.

The region determination unit 740 determines a first segmentation region including the position of the pointer or the optimum position information, using the range of the brightness value calculated by the estimation unit 730 and determines an optimum segmentation region by applying a predetermined fitting model, for example, a deformable model or a snake model to the determined first segmentation region.

The comparison unit 710 for comparing the brightness value of the position of the pointer with the mean value and the detection unit 720 for detecting the optimum position information have been illustrated and described as being the element blocks of the determination unit 620 in FIG. 7, but the present invention is not limited thereto. The comparison unit 710 and the detection unit 720 may become the detailed element blocks of the extraction unit 610.

Referring back to FIG. 6, the display unit 630 preliminarily displays the segmentation region determined by the determination unit 620, that is, the optimum segmentation region, in the slice medical image displayed on a screen.

If the user checks the segmentation region displayed by the display unit 630, satisfies the segmentation region preliminarily displayed on the screen, and affirms the preliminarily displayed segmentation region, the decision unit 640 determines the affirmed segmentation region as a lesion diagnosis region for the slice medical image displayed on the screen.

Here, the segmentation region determined by the decision unit 640 may be used as a seed for the segmentation of a 3D volume image.

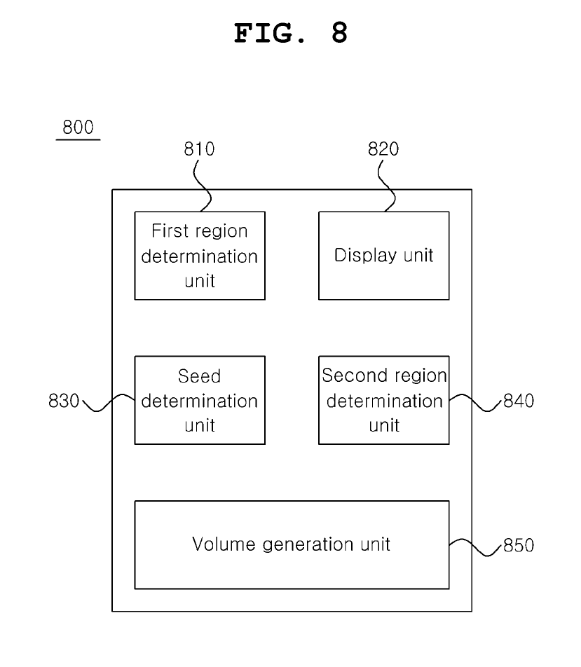

FIG. 8 shows the configuration of a segmentation apparatus of a medical image in accordance with another embodiment of the present invention and shows the configuration of the apparatus for the flowchart of FIG. 4.

Referring to FIG. 8, the segmentation apparatus 800 includes a first region determination unit 810, a display unit 820, a seed determination unit 830, a second region determination unit 840, and a volume generation unit 850.

The first region determination unit 800 determines a segmentation region including the position of a pointer, based on information about a first slice medical image, for example, a brightness value which is related to information about the position of the pointer that has been extracted in response to a user input from the first slice medical image displayed on a screen.

Here, the first region determination unit 810 may include the extraction unit 610 shown in FIG. 6 and the comparison unit 710, the detection unit 720, the estimation unit 730, and the region determination unit 740 which are shown in FIG. 7.

The display unit 820 preliminarily displays the segmentation region, determined by the first region determination unit 810, in the first slice medical image displayed on a screen.

If the segmentation region preliminarily displayed in the first slice medical image is affirmed by the user, the seed determination unit 830 determines the affirmed segmentation region to a seed for the segmentation of a 3D volume image.

The second region determination unit 840 determines the segmentation region of each of a plurality of slice medical images related to the first slice medical image based on the segmentation seed determined by the seed determination unit 830.

The volume generation unit 850 generates a 3D segmentation volume using the segmentation seed determined by the seed determination unit 830 and the segmentation region of each of the slice medical images determined by the second region determination unit 840.

In accordance with the present invention, a segmentation region including the position of a pointer according to a user input in a slice medical image is preliminarily displayed. When the preliminarily displayed segmentation region is affirmed by the user through an interaction with the user, the segmentation of other slice medical images for generating a 3D segmentation volume using the affirmed segmentation region as a seed is performed. Accordingly, an optimum 3D segmentation volume can be generated by obtaining an optimum segmentation seed.

Moreover, in accordance with the present invention, an optimum segmentation seed can be determined through a pre-segmentation process for an interaction with a user, and a system load for generating a 3D segmentation volume can be reduced through an interaction with a user.

More particularly, in accordance with the present invention, an optimum segmentation seed can be affirmed by a user because pre-segmentation results according to the position of a pointer are preliminarily displayed on a screen so that they are affirmed by the user, and a load applied to generate a 3D segmentation volume can be reduced because a segmentation seed is determined in response to a user' affirmation.

In other words, in accordance with the present invention, the validity of pre-segmentation results can be rapidly verified because a user can determine whether or not to adopt the pre-segmentation results in a 2D slice image that is now being displayed to the user. Furthermore, since pre-segmentation results adopted by a user have been primarily verified, excellent 3D segmentation results can be obtained while using relatively small resources when performing segmentation in a 3D image using the verified pre-segmentation results as a seed region including excellent information.

Furthermore, the present invention can provide convenience to a user because a pre-segmentation process is performed based on a user input, for example, information about the position of a pointer (or mouse) and thus a user input and a user interface are made simple and can reduce an overall system load by reducing a conventional 3D segmentation volume generation process that is repeated owing to unsatisfactory segmentation results.

The segmentation method of a medical image in accordance with an embodiment of the present invention can be implemented in the form of a program executable by various computer means, and can be stored in a computer-readable recording medium. The computer-readable medium can include a program, a data file, a data structure, etc. solely or in combination. Meanwhile, the program recorded on the recording medium may have been specially designed and configured for the present invention, or may be known to those skilled in computer software. The computer-readable recording medium includes a hardware device specially configured to store and execute the program, such as a magnetic medium such as a hard disk, a floppy disk, and a magnetic tape, an optical medium such as a CD-ROM or DVD, or a magneto-optical medium, such as a floptical disk, ROM, RAM, or flash memory. Furthermore, the program may include both machine-language code, such as code written by a compiler, and high-level language code, which is executable by a computer using an interpreter. The hardware device can be configured in the form of one or more software modules for executing the operation of the present invention, and the vice versa

As described above, although the embodiments of the present invention have been described in connection with specific matters, such detailed elements, and the limited embodiments and drawings, they are provided only to help general understanding of the present invention, and the present invention is not limited to the embodiments. A person having ordinary skill in the art to which the present invention pertains may modify the present invention in various ways from the above description.

Accordingly, the spirit of the present invention should not be construed as being limited to the embodiments, and not only the claims to be described later, but also all equal or equivalent modifications thereof should be constructed as belonging to the category of a spirit of the present invention.

What is claimed is:

1. A segmentation method of a medical image, comprising:
extracting, by a processor, information about a position of a pointer according to a user input from a slice medical image displayed on a screen;
determining, by the processor, a segmentation region including the position of the pointer, based on information about the slice medical image related to the extracted information about the position of the pointer;
preliminarily displaying, by the processor, the determined segmentation region in the slice medical image; and
when the preliminarily displayed segmentation region is affirmed by a user, determining, by the processor, the affirmed segmentation region as a lesion diagnosis region for the slice medical image.

2. The segmentation method of claim 1, wherein the determining the affirmed segmentation region further includes determining, by the processor, the lesion diagnosis region as a seed for a segmentation of a 3D volume image.

3. The segmentation method of claim 1, wherein the determining the segmentation region further comprising:
removing, by the processor, granular noise from the slice medical image;
distinguishing, by the processor, a lesion diagnosis portion using a profile of the slice medical image from which the granular noise has been removed; and
determining, by the processor, the segmentation region including the position of the pointer, based on the distinguished lesion diagnosis portion and the information about the slice medical image that is related to the extracted information about the position of the pointer.

4. The segmentation method of claim 1, wherein:
the extracting further includes detecting, by the processor, optimum position information in a predetermined neighboring region including the position of the pointer and other positions having a brightness value same as the brightness value of the position of the pointer, and
the determining the segmentation region further includes determining, by the processor, the segmentation region including the position of the pointer, based on the information about the slice medical image that is related to the detected optimum position information.

5. The segmentation method of claim 4, wherein the extracting further includes:
comparing, by the processor, a mean value of brightness values of the predetermined neighboring region with the brightness value of the position of the pointer, and
detecting, by the processor, position information corresponding to the mean value as the optimum position information if the brightness value of the position of the pointer lies out of a predetermined tolerance range of the mean value.

6. The segmentation method of claim 1, wherein the determining the segmentation region further comprising:
estimating, by the processor, a range of a brightness value based on the information about the slice medical image that is related to the extracted information about the position of the pointer;
determining, by the processor, a first segmentation region including the position of the pointer using the estimated range of the brightness value;
applying, by the processor, a predetermined fitting model to the determined first segmentation region; and
determining, by the processor, an optimum segmentation region from the first segmentation region using the fitting model.

7. The segmentation method of claim 1, wherein the determining the segmentation region further includes:
detecting, by the processor, one or more segmentation regions corresponding to a brightness value of the position of the pointer using density distribution information of the slice medical image, and
determining, by the processor, a segmentation region including the position of the pointer, from the detected one or more segmentation regions.

8. A segmentation method of a medical image, comprising:
determining, by a processor, a segmentation region including a position of a pointer, based on information about a first slice medical image that is related to information about the position of the pointer, in the first slice medical image;
preliminarily displaying, by the processor, the determined segmentation region in the first slice medical image;
when the preliminarily displayed segmentation region is affirmed by a user, determining, by the processor, the affirmed segmentation region as a seed for a segmentation of a 3D volume image; and
determining, by the processor, a segmentation region of each of a plurality of slice medical images related to the first slice medical image based on the determined seed.

9. The segmentation method of claim 8, further comprising:
generating, by the processor, a 3D segmentation volume using the determined seed and the segmentation region of each of the plurality of the slice medical images.

10. The segmentation method of claim 8, wherein the determining the segmentation region including the position of the pointer further comprising:
comparing, by the processor, a brightness value of the position of the pointer with a mean value of brightness values of a predetermined neighboring region including the position of the pointer;
detecting, by the processor, optimum position information in the neighboring region when the brightness value of the position of the pointer lies out of a predetermined tolerance range of the mean value;
estimating, by the processor, a range of a brightness value for segmentation based on a brightness value of the detected optimum position information;
determining, by the processor, a first segmentation region including the position of the pointer using the estimated range of the brightness value; and
determining, by the processor, an optimum segmentation region by applying a fitting model to the determined first segmentation region.

11. A segmentation apparatus of a medical image, comprising a processor configured to:
extract information about a position of a pointer according to a user input from a slice medical image displayed on a screen;
determine a segmentation region including the position of the pointer, based on information about the slice medical image related to the extracted information about the position of the pointer;
preliminarily display the determined segmentation region in the slice medical image; and
when the preliminarily displayed segmentation region is affirmed by a user, determine the affirmed segmentation region as a lesion diagnosis region for the slice medical image.

12. The segmentation apparatus of claim 11, wherein the processor is further configured to determine the lesion diagnosis region as a seed for a segmentation of a 3D volume image.

13. The segmentation apparatus of claim 11, wherein the processor is further configured to:
compare a brightness value of the position of the pointer with a mean value of brightness values of a predetermined neighboring region including the position of the pointer;
detect optimum position information in the neighboring region if the brightness value of the position of the pointer lies out of a predetermined tolerance range of the mean value;
estimate a range of a brightness value for segmentation based on a brightness value of the detected optimum position information; and
determine a first segmentation region including the position of the pointer using the estimated range of the brightness value and determine an optimum segmentation region by applying a fitting model to the determined first segmentation region.

14. A segmentation apparatus of a medical image, comprising a processor configured to:
determine a segmentation region including a position of a pointer, based on information about a first slice medical image that is related to information about the position of the pointer, in the first slice medical image;
preliminarily display the determined segmentation region in the first slice medical image;
when the preliminarily displayed segmentation region is affirmed by a user, determine the affirmed segmentation region as a seed for a segmentation of a 3D volume image; and
determine a segmentation region of each of a plurality of slice medical images related to the first slice medical image based on the determined seed.

15. The segmentation apparatus of claim 14, the processor further configured to generate a 3D segmentation volume using the determined seed and the segmentation region of each of the plurality of the slice medical images.
